(19) United States
(12) Patent Application Publication
(10) Pub. No.: US 2015/0230165 A1
(43) Pub. Date: Aug. 13, 2015

(54) COMMUNICATION APPARATUS, COMMUNICATION METHOD, NON-TRANSITORY COMPUTER READABLE MEDIUM, AND DISTRIBUTION SERVER

(71) Applicant: NEC Corporation, Tokyo (JP)

(72) Inventors: Hiroaki Aminaka, Tokyo (JP); Kojiro Hamabe, Tokyo (JP); Hiroto Sugahara, Tokyo (JP)

(73) Assignee: NEC Corporation, Tokyo (JP)

(21) Appl. No.: 14/420,343

(22) PCT Filed: Mar. 8, 2013
(86) PCT No.: PCT/JP2013/001526

§ 371 Date: Feb. 6, 2015

(30) Foreign Application Priority Data
Aug. 6, 2012 (JP) 2012-173856

(51) Int. Cl. H04W 48/18; H04W 48/08

(52) U.S. Cl. CPC H04W 48/18; H04W 48/08; H04W 88/06

(57) ABSTRACT

In one embodiment, a first mobile station (3) can be wirelessly connected to a first network (5) and can be wirelessly connected to a second mobile station (4) that is wirelessly connected to a second network (6). The first mobile station (3) performs control on whether to be wirelessly connected to the first network (5) or the second mobile station (4) in accordance with the network selected from the first network (5) or the second network (6) based on information regarding the second network (6). It is thus for example possible to contribute to an efficient selection of a communication path of the first mobile station (3) that can use both of a first communication path that is via a direct wireless connection to the first network (5) and a second communication path that is via a wireless connection to another mobile station (4).

### TECHNICAL FIELD

The present application relates to a wireless communication system, and in particular, to control of a communication path of a mobile station.

### BACKGROUND ART

A mobile station such as a mobile router or a smartphone having a tethering function is well known. Such a mobile station operates as a bridge or a router for transferring data of another wireless terminal. Such a mobile station is connected to a mobile network (e.g., a cellular network or a public wireless LAN (Local Area Network)) that is provided by a mobile operator (a wireless service provider) and also connected to another wireless terminal using another wireless technology such as a wireless LAN (Local Area Network) or a wireless PAN (Personal Area Network). In this way, the mobile station enables another wireless terminal to perform a communication with an end node through a mobile network. Note that the end node is, for example, a server computer or a personal computer that is disposed in an external network (e.g., a packet data network, an IP (Internet Protocol) network, or the Internet) or another mobile station that is connected to a mobile network. Further, the communication with the end node is, for example, internet access, a VoIP (Voice over Internet Protocol) call, a voice chat, a video chat, video streaming, or an online game.

Patent Literature 1 discloses control of a communication path when a wireless terminal communicates with an end node via a mobile station. In a wireless communication system disclosed in Patent Literature 1, each of a plurality of mobile stations can establish a wireless connection to a wireless terminal and also to a mobile network. Further, the plurality of mobile stations can communicate with each other in order to evaluate which one of the mobile stations can provide the most appropriate wireless network connection (a connection to the mobile network). As an example, one of the plurality of mobile stations evaluates which one of the mobile stations can provide the most appropriate wireless network connection (the connection with the mobile network). As another example, the mobile network evaluates which one of the mobile stations can provide the most appropriate network connection (a connection to the mobile network). In this case, the mobile network can request the plurality of mobile stations to send their respective network connectivity capabilities.

### CITATION LIST

### Patent Literature

Patent Literature 1: International Patent Publication No. WO 03/039178

### SUMMARY OF INVENTION

### Technical Problem

The present inventors have investigated control for selecting a communication path of a mobile station (referred to as a first mobile station) which has a function for communicating with an end node via a direct wireless connection to a mobile network and also a function for communicating with the end node via another mobile station (a second mobile station) such as a mobile router or a smartphone having a tethering function. An example of the first mobile station is a multi-mode terminal that supports both a wireless access technology of a cellular network (e.g., UTRAN (UMTS Terrestrial Radio Access Network), E-UTRAN (Evolved UTRAN), GERAN (GSM EDGE Radio Access Network), or WiMAX (Worldwide Interoperability for Microwave Access)) and a wireless access technology of a wireless LAN or a wireless PAN. The first mobile station as a multi-mode terminal can establish a direct wireless connection to a base station in a cellular network and also a wireless connection to the second mobile station using the wireless access technology of the wireless LAN or wireless PAN. Another example of the first mobile station is a wireless LAN terminal. The wireless LAN terminal can be connected to a plurality of wireless LANs with SSIDs (Service Set Identifiers) different from each other. Specifically, the first mobile station as a wireless LAN terminal can establish a direct wireless connection to a base station (e.g., an access point) in a mobile network (e.g., a public wireless LAN service) and also establish a wireless connection to another mobile station that functions as a mobile router.

The present inventors have found a problem in regard to a selection of a communication path for the above-mentioned first mobile station to communicate with an end node. In order to communicate with the end node, the first mobile station can use both a first path through the mobile network, to which the first mobile station can establish a direct wireless connection, and a second path via the second mobile station. Most simply, it is possible for the first mobile station to compare qualities of two wireless connections in order to decide on the communication path. That is, the first mobile station may compare a quality of a first wireless connection to the mobile network and a quality of a second wireless connection to the second mobile station and may use the wireless connection with the better quality for a communication with the end node.

However, when the second mobile station is a mobile router, a smartphone or the like having a tethering function, generally one user has and uses both the first and second mobile stations. In such a case, the quality of the second wireless connection is almost always better than the quality of the first wireless connection. Thus, the first mobile station always selects the communication path that is via the second mobile station. However, even when the quality of the short-distance wireless connection between the first and second mobile stations is good, the quality of the communication from the second mobile station to the end node is not necessarily good.

Accordingly, one of the objects of the present invention is to provide a communication apparatus, a communication method, a program, and a distribution server that contribute to an efficient selection of a communication path of a mobile station that can use both a first communication path via a direct first wireless connection to a mobile network and a second communication path via a second wireless connection to another mobile station.

### Solution to Problem

In a first exemplary aspect, a communication apparatus, capable of communicating by a plurality of wireless access technologies, includes a first communication unit, a second communication unit, and a control unit. The first communication unit is configured to be wirelessly connected to a first network. The second communication unit is configured to be wirelessly connected to another communication apparatus that is wirelessly connected to a second network. The control unit operates to perform control on whether to use either the first communication unit or the second communication unit in accordance with the network selected from the first and second networks based on information regarding the second network.

In a second exemplary aspect, a communication method performed by a communication apparatus including a first communication unit capable of being wirelessly connected to a first network and a second communication unit capable of being wirelessly connected to another communication apparatus that is wirelessly connected to a second network is provided. The communication method includes: performing control on whether to use either the first communication unit or the second communication unit in accordance with the network selected from the first and second networks based on information regarding the second network; and communicating through the first network or the second network.

In a third exemplary aspect, a communication apparatus, capable of communicating by a plurality of wireless access technologies, includes a first communication unit, a second communication unit, and a control unit. The first communication unit is configured to be wirelessly connected to a first network. The second communication unit is configured to be wirelessly connected to another communication apparatus that is wirelessly connected to a second network. The control unit operates to select either of the first network or the second network to be used by the another communication apparatus based on information regarding the second network.

In a fourth exemplary aspect, a communication method performed by a communication apparatus including a first communication unit capable of being wirelessly connected to a first network and a second communication unit capable of being wirelessly connected to another communication apparatus that is wirelessly connected to a second network is provided. The communication method includes: selecting either of the first network or the second network to be used by the another communication apparatus based on information regarding the second network; and communicating through the selected network.

In a fifth exemplary aspect, a program causes a communication apparatus to execute a process. The communication apparatus includes a first communication unit capable of being wirelessly connected to a first network and a second communication unit capable of being wirelessly connected to another communication apparatus that is wirelessly connected to a second network. The process includes performing control on whether to use either the first communication unit or the second communication unit in accordance with the network selected from the first and second networks based on information regarding the second network.

In a sixth exemplary aspect, a program causes a communication apparatus to execute a process. The communication apparatus includes a first communication unit capable of being wirelessly connected to a first network and a second communication unit capable of being wirelessly connected to another communication apparatus that is wirelessly connected to a second network. The process includes selecting either of the first network or the second network to be used by the another communication apparatus based on information regarding the second network.

In a seventh exemplary embodiment, a distribution server operates to distribute the program according to the above-mentioned fifth exemplary aspect to the communication apparatus.

In an eighth exemplary embodiment, a distribution server operates to distribute the program according to the above-mentioned sixth exemplary aspect to the communication apparatus.

### Advantageous Effects of Invention

According to the above-mentioned exemplary aspects, it is possible to provide a communication apparatus, a communication method, a program, and a distribution server that contribute to an efficient selection of a communication path of a mobile station that can use both a first communication path via a direct first wireless connection to a mobile network and a second communication path via a second wireless connection to another mobile station.

### BRIEF DESCRIPTION OF DRAWINGS

FIG. 1 is a diagram illustrating a configuration example of a wireless communication network according to a first exemplary embodiment;

FIG. 2 is a flowchart showing a decision procedure of a communication path of a mobile station according to the first exemplary embodiment;

FIG. 3 is a block diagram showing a configuration example of a mobile station according to the first exemplary embodiment;

FIG. 4 is a block diagram showing a configuration example of a mobile station (e.g., a mobile router) according to the first exemplary embodiment;

FIG. 5 is a block diagram showing a configuration example of a control apparatus according to the first exemplary embodiment;

FIG. 6 is a block diagram showing a configuration example of the mobile station according to the first exemplary embodiment;

FIG. 7 is a sequence diagram showing a decision procedure of a communication path of a mobile station according to a second exemplary embodiment;

FIG. 8 is a flowchart showing an operation example of the mobile station according to the second exemplary embodiment;

FIG. 9 is a block diagram showing an operation example of the mobile station (e.g., a mobile router) according to the second exemplary embodiment;

FIG. 10 is a sequence diagram showing a decision procedure of a communication path of a mobile station according to a third exemplary embodiment;

FIG. 11 is a flowchart showing an operation example of the mobile station according to the third exemplary embodiment;

FIG. 12 is a block diagram showing an operation example of the mobile station (e.g., a mobile router) according to the third exemplary embodiment;

FIG. 13 is a sequence diagram showing a decision procedure of a communication path of a mobile station according to a fourth exemplary embodiment;

FIG. 14 is a flowchart showing an operation example of a control apparatus according to the fourth exemplary embodiment;

FIG. 15 is a flowchart showing an operation example of a network apparatus according to the fourth exemplary embodiment;

FIG. 16 is a flowchart showing an operation example of a mobile station (e.g., a mobile router) according to the fourth exemplary embodiment;

FIG. 17 is a sequence diagram showing a decision procedure of a communication path of a mobile station according to a fifth exemplary embodiment;

FIG. 18 is a block diagram showing an operation example of the mobile station (e.g., a mobile router) according to the fifth exemplary embodiment;

FIG. 19 is a sequence chart showing an operation example according to a sixth exemplary embodiment; and

FIG. 20 is a diagram showing a configuration example of a system according to a seventh exemplary embodiment.

### DESCRIPTION OF EMBODIMENTS

Hereinafter, specific exemplary embodiments shall be explained in detail with reference to the drawings. The same or corresponding components are denoted by the same reference symbols throughout the drawings, and repeated explanations will be omitted as necessary for clarity of the explanation.

### First Exemplary Embodiment

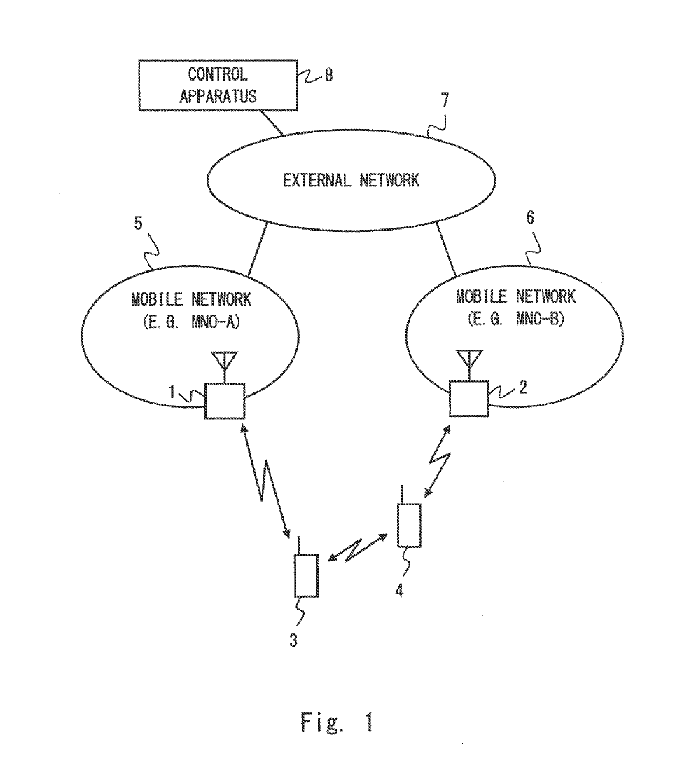

FIG. 1 is a block diagram showing a configuration example of a wireless communication network according to this exemplary embodiment. A mobile station 3 is configured to establish a first wireless connection to a base station 1 that is included in a mobile network 5 and also to establish a second wireless connection to a mobile station 4, in order to communicate with an end node. The wireless access technology (a wireless access scheme) that is used in the second wireless connection may be the same as or different from that used in the first wireless connection. The mobile station 3 may be, for example, a multi-mode terminal, while the mobile network 5 may be, for example, a cellular network including a wireless access network and a core network. The mobile station 3 as the multi-mode terminal may establish a wireless connection to the base station 1 using a wireless access technology (e.g., URAN, E-UTRAN, GERAN, or WiMAX) of the cellular network. Meanwhile, the mobile station 3 as a multi-mode terminal may establish a wireless connection to the mobile station 4 using a wireless access technology of a wireless LAN that is compliant with IEEE 802.11 series or a wireless PAN (e.g., Bluetooth) that is compliant with IEEE 802.15 series. Alternatively, the mobile station 3 may be a wireless LAN terminal, while the mobile network 5 may be a public wireless LAN. In this case, the mobile station 3 as a wireless LAN terminal can establish a wireless connection to the mobile station 4 or the base station 1 (i.e. an access point) within a public wireless LAN.

The mobile station 4 is configured to establish a third wireless connection to the base station 2 that is included in the mobile network 6 and also to transfer data of the mobile station 3 to the mobile network 6, in order to contribute to communications between the mobile station 3 and the end node. That is, the mobile station 4 operates as a bridge or a router in order to transfer the data of the mobile station 3. The wireless access technology that is used in the third wireless connections may be the same as or different from that used in the second wireless connection. The mobile station 4 is, for example, an apparatus such as a mobile router, smartphone or the like having a tethering function that can establish a connection to the mobile network 6 and a connection to the mobile station 3 at the same time. The mobile station 4 as a mobile router (or a smartphone having a tethering function) may establish a wireless connection to the base station 2 by the wireless access technology (e.g., URAN, E-UTRAN, GERAN, or WiMAX) of the cellular network. Meanwhile, the mobile station 4 as a mobile router may establish a wireless connection to the mobile station 3 by the wireless access technology of the wireless LAN or the wireless PAN.

The mobile network 6 is typically a network to which the mobile station 3, which is capable of being connected to the mobile network 5, cannot directly access. As an example, two mobile networks 5 and 6 may be networks that are operated by mobile network operators (wireless service providers) different from each other. At least one of the mobile network operators may be an MVNO (Mobile Virtual Network Operator). In this case, by the limitation of the service use contract, the mobile station 3 cannot access the mobile network 6. As another example, the two mobile networks 5 and 6 may be different cellular wireless systems that are operated by the same or different mobile network operators. The different cellular wireless systems generally request the mobile stations to support different wireless access technologies or different NAS protocols. Accordingly, in this case, the mobile station 3 cannot access the mobile network 6 due to a technical limitation.

The external network 7 is a network with which the mobile station 3 or 4 can communicates through the mobile network 5 or 6. The external network 7 is, for example, a packet data network, an IP (Internet Protocol) network, the Internet, or another mobile network. The end node that communicates with the mobile station 3 may be, for example, a server computer, a personal computer, or a mobile station that is positioned in the external network 7. Alternatively, the end node may be another mobile station that is connected to the mobile network 5 or 6. Although a communication between the mobile station 3 and the end node is, for example, internet access, a VoIP call, a voice chat, a video chat, video streaming, or an online game, it is not limited to them.

Further, the configuration shown in FIG. 1 includes a control apparatus 8. Note that the control apparatus 8 may be omitted except for the case in which the control apparatus 8 participates in making a decision about the communication path of the mobile station 3, which will be explained later. In the example of FIG. 1, the control apparatus 8 is connected to the external network 7. The control apparatus 8 may, however, be directly connected to the mobile network 5 or 6 without the external network 7 being interposed between them. The control apparatus 8 may be a network management system that is operated by an operator (a wireless service provider) of the mobile network 5 or 6. The network management system is sometimes referred to as an OAM (Operation Administration and Maintenance) server, an OMC (Operation and Maintenance Centre), an NM (Network Manager), or an EM (Element Manager). Alternatively, the control apparatus 8 may be operated by a third party that is independent from the operator(s) of the mobile network 5 and 6. In this case, the control apparatus 8 may send and receive user data packets to and from one or both of the mobile station 3 and 4 in order to send and receive signaling messages. The user data packets are transferred transparently through the mobile network 5 and 6 and reach the mobile stations 3 and 4 and the control apparatus 8. Alternatively, the control apparatus 8 may connect the mobile network 5 or 6 or a management system of the mobile network 5 or 6 to an interface (e.g., API (Application Programming Interface)) in order to send and receive signaling messages.

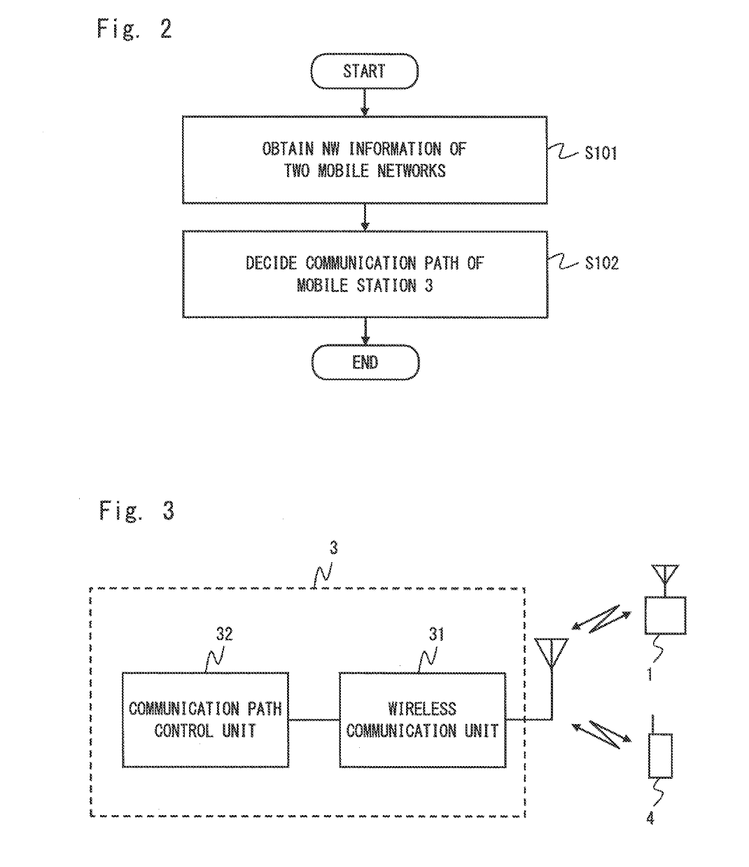

Hereinafter, a procedure for deciding on the communication path of the mobile station 3 shall be explained with reference to FIG. 2. In this exemplary embodiment, the mobile station 3, the mobile station 4, or the control apparatus 8 includes a processing unit for executing an operation shown in FIG. 2 in order to decide on the communication path of the mobile station 3. In Step S101, the processing unit obtains network information regarding the two mobile networks 5 and 6. Note that the processing unit may obtain the network information regarding at least one of the mobile networks 5 and 6. The network information may indicate a wireless quality (e.g., reception power, RSCP (Received Signal Code Power), RSRP (Reference Signal Received Power), Ec/No, SINR (Signal to Interference plus Noise Ratio) or BER (Bit Error Rate)). Further or alternatively, the network information may indicate a load of the mobile network. The load of the mobile network is, for example, a wireless resource load (e.g., a noise level and wireless resource utilization) or a network load (e.g., a processing load of a network apparatus such as a base station, network resource utilization, or a core network channel usage rate).

In Step S102, the processing unit decides on the communication path of the mobile station 3 based on the network information regarding the two mobile networks 5 and 6. Specifically, the processing unit decides which one of the first communication path that is via the first wireless connection directly connected to the mobile network 5 and the second communication path that is via the second wireless connection connected to the mobile station 4 (e.g., a mobile router) is appropriate for the communication path of the mobile station 3. Note that the processing unit may not use the network information of both the mobile networks 5 and 6 to decide the communication path. For example, when the network information regarding one of the mobile networks 5 and 6 is obtained, the processing unit may decide the communication path based on the network information regarding this one of the mobile networks 5 and 6.

The decision on the communication path of the mobile station 3 can be made in light of various factors according to the network information to be used. The decision on the communication path of the mobile station 3 may be made, for example, in light of an improvement of a throughput. In this case, for example, the communication path that is through one of the mobile networks 5 and 6 with a better wireless quality or a smaller network load may be selected as the communication path of the mobile station 3. Alternatively, the decision on the communication path may be made in light of a reduction of the load of the mobile network 5 or 6 or an improvement of resource utilization (wireless resource utilization or network resource utilization). In this case, for example, the communication path that is through one of the mobile networks 5 and 6 with a lower load or lower utilization may be selected as the communication path of the mobile station 3.

The result of the decision on the communication path of the mobile station 3 made by the processing unit is reflected in the mobile station 3. For example, the processing unit disposed in the mobile station 3 may control circuits (e.g., a baseband processor and a wireless transceiver) inside the mobile station 3 to use the first communication path. The processing unit disposed in the mobile station 4 or the control apparatus 8 may notify the mobile station 3 of the communication path by sending a message to the mobile station 3. Further, the processing unit disposed in the mobile station 4 may stop wireless transmissions by the mobile station 4 on the second wireless connection to the mobile station 3. By doing so, the second communication path that is via the mobile station 4 changes from being available to unavailable, and the mobile station 3 can thus autonomously select the first communication path that is through the mobile network 5.

As has already been mentioned, the processing unit for deciding the communication path of the mobile station 3 is disposed in the mobile station 3, the mobile station 4, or the control apparatus 8. Hereinafter, configuration examples of the mobile station 3, the mobile station 4, and the control apparatus 8 that include the processing unit shall be explained with reference to FIGS. 3 to 6. FIG. 3 is a block diagram showing the configuration example of the mobile station 3 including the processing unit. A wireless communication unit 31 is wirelessly connected to the base station 1 within the mobile network 5 and can communicate with the end node via the mobile network 5. Moreover, the wireless communication unit 31 is wirelessly connected to the mobile station 4 and can communicate with the end node via the mobile station 4 and the mobile network 6. The wireless communication unit 31 may include a plurality of wireless transceivers that are compliant with a plurality of wireless access technologies. A communication path control unit 32 corresponds to the processing unit for deciding the communication path of the mobile station 3. The communication path control unit 32 decides the communication path of the mobile station 3 based on the network information regarding the mobile networks 5 and 6. The network information regarding the mobile network 5 may be autonomously obtained by the mobile station 3 (the wireless communication unit 31) or may be supplied to the mobile station 3 from the control apparatus 8. Further, the network information regarding the mobile network 6 may be supplied to the mobile station 3 from the mobile station 4 or the control apparatus 8.

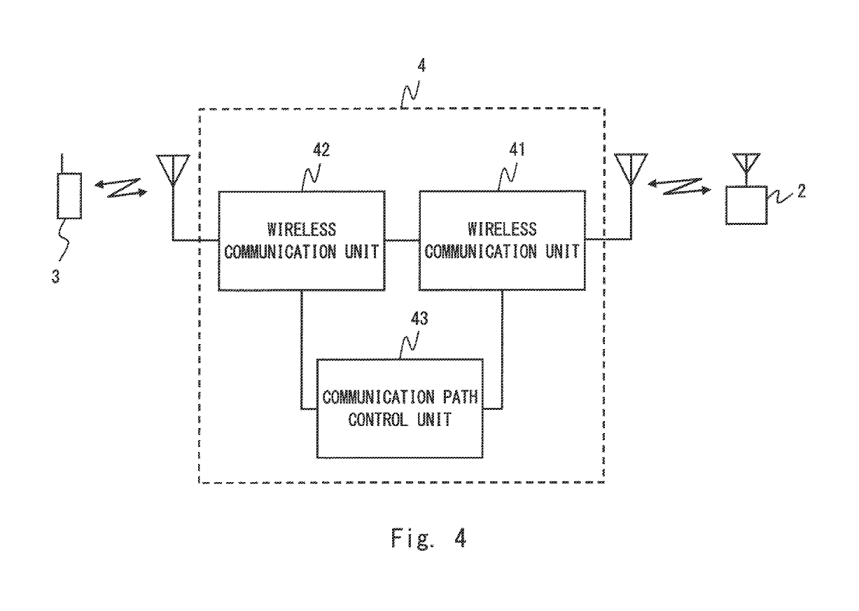

FIG. 4 is a block diagram showing the configuration example of the mobile station 4 including the processing unit. The mobile station 4 is, for example, a mobile router and relays data, sent from the mobile station 3 and data to be received by the mobile station 3, between the mobile network 6 and the mobile station 3. A wireless communication unit 41 is wirelessly connected to the base station 2 within the mobile network 6 and can communicate with the mobile network 6. A wireless communication unit 42 is wirelessly connected to the mobile station 3 and can communicate with the mobile station 3. A communication path control unit 43 corresponds to the processing unit for deciding on the communication path of the mobile station 3. The communication path control unit 43 decides on the communication path of the mobile station 3 based on the network information regarding the mobile networks 5 and 6. The network information regarding the mobile network 5 may be autonomously obtained by the mobile station 4 (the wireless communication unit 41 or 42) or may be supplied to the mobile station 4 from the mobile station 3 or the control apparatus 8. Moreover, the network information regarding the mobile network 6 may be autonomously obtained by the mobile station 4 (the wireless communication unit 41) or may be supplied to the mobile station 4 from the control apparatus 8.

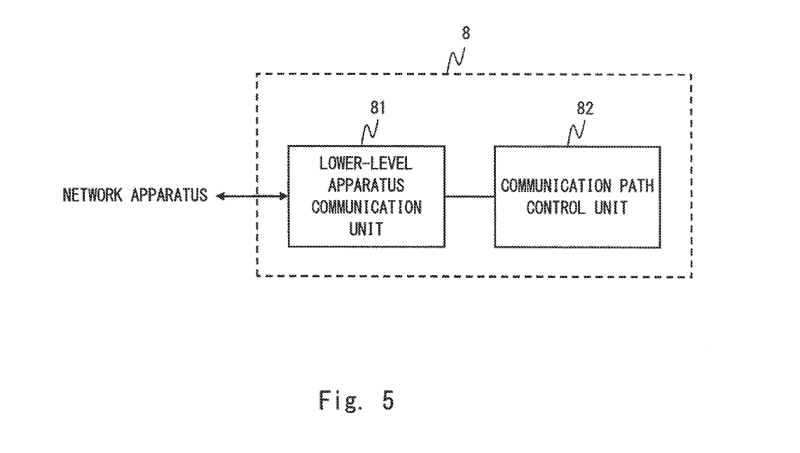

FIG. 5 is a block diagram showing the configuration example of the control apparatus 8 including the processing unit. A lower-level apparatus communication unit 81 communicates with: the mobile network 5 or 6; the base station 1 or 2; another network node disposed in the mobile station 3 or 4; or a network management system. A communication path control unit 82 corresponds to the processing unit for deciding on the communication path of the mobile station 3. The communication path control unit 82 decides on the communication path of the mobile station 3 based on the network information regarding the mobile networks 5 and 6. The network information regarding the mobile networks 5 and 6 may be supplied to the control apparatus 8 from the mobile stations 3 and 4 or supplied to the control apparatus 8 from the mobile networks 5 and 6.

The processing unit for deciding on the communication path of the mobile station 3 may be implemented by using a semiconductor processing device including an ASIC (Application Specific Integrated Circuit). Further, the processing unit for deciding the communication path of the mobile station 3 may be implemented by causing a computer system including at least one processor (e.g., a microprocessor, an MPU (Micro Processing Unit), and a CPU (Central Processing Unit)) to execute a program. More specifically, one or more programs including instructions for causing a computer to execute an algorithm related to the decision on the communication path of the mobile station 3 may be created, and the program may be supplied to the computer.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

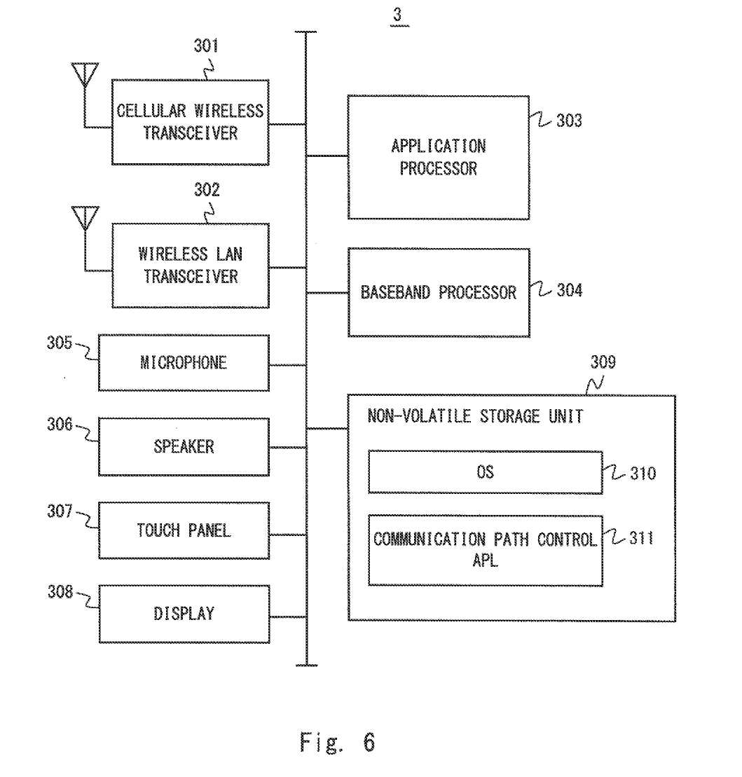

FIG. 6 is a block diagram showing a configuration example when the mobile station 3 including the processing unit is manufactured using a computer system. As a specific example of the wireless communication unit 31, the example of FIG. 6 includes a cellular wireless transceiver 301, a wireless LAN transceiver 302, an application processor 303, and a baseband processor 304. Further, the example of FIG. 6 includes a microphone 305, a speaker 306, a touch panel 307, and a display 308 as specific examples of input devices and output devices.

The application processor 303 executes a system software program (OS (Operating System)) 310 and various application programs (e.g., a WEB browser and a mailer) that are read from a non-volatile storage unit 309, thereby providing various functions of the mobile station 3. The non-volatile storage unit 309 is, for example, a flash memory or a hard disk drive. The application processor 303 also executes a communication path control application 311, thereby providing the functions of the processing unit (the communication path control unit 32) that have been mentioned in this exemplary embodiment.

As mentioned above, in this exemplary embodiment, the communication of the mobile station 3, which can use both the first communication path via the first wireless connection directly connected to the mobile network 5 and the second communication path via the second wireless connection to the mobile station 4, is decided on based on the network information regarding the mobile networks 5 and 6. As mentioned above, when the mobile station 4 is a mobile router or a smartphone having a tethering function, it is considered that one user has and uses both of the mobile stations 3 and 4. In such a case, since the quality of the second wireless connection is almost always better than the quality of the first wireless connection, the communication path may not be appropriately selected by a comparison between the qualities of the first and second wireless connections. On the other hand, in this exemplary embodiment, the network information regarding the mobile networks 5 and 6 are used to decide on the communication path of the mobile station 3, it is thus possible to efficiently decide on the communication path based on factors such as an improvement of connection stability of the mobile station 3, an improvement of a throughput, a reduction of a network load, and an efficient use of network resources.

### Second Exemplary Embodiment

In this exemplary embodiment, a specific example of the first exemplary embodiment shall be explained. A network configuration of this exemplary embodiment may be the same as that shown in FIG. 1. In this exemplary embodiment, the processing unit for deciding on the communication path of the mobile station 3 is disposed in the mobile station 4 (e.g., a mobile router). Further, the mobile station 4 obtains the network information regarding the two mobile networks 5 and 6 without receiving this from the mobile station 3, and then decides on the communication path of the mobile station 3.

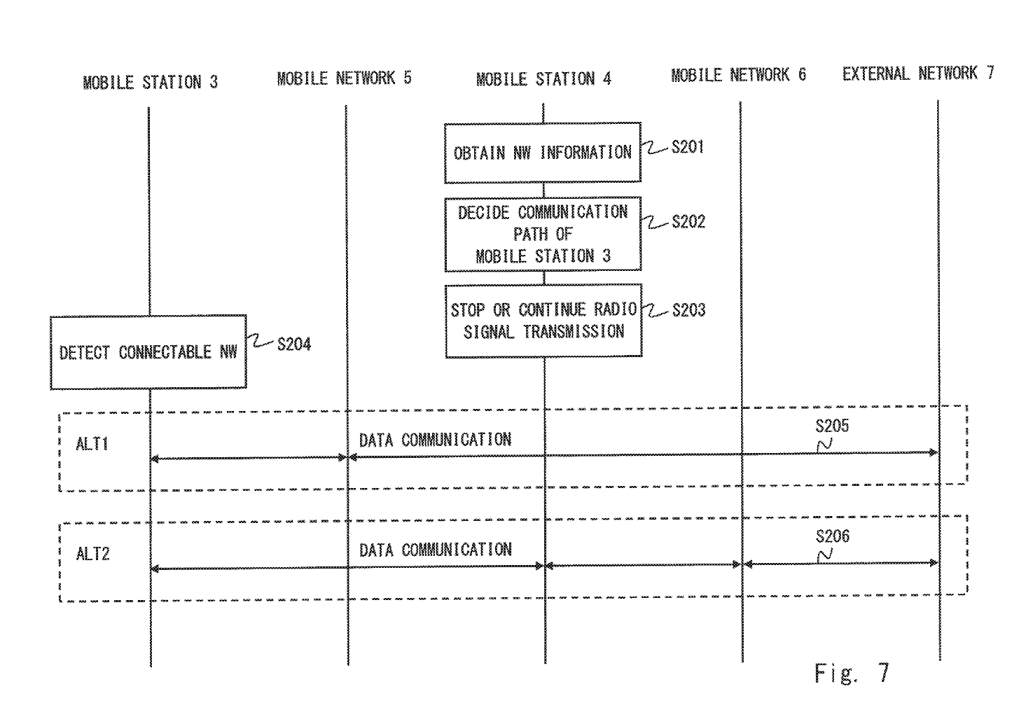

FIG. 7 is a sequence showing a specific operation example of this exemplary embodiment. FIG. 7 shows operations of the mobile stations 3 and 4, the mobile networks 5 and 6, and the external network 7. In Step S201, the mobile station 4 obtains the network information regarding the mobile networks 5 and 6. In a preferable implementation, the mobile station 4 may measure a radio signal from the mobile network 5 using its own wireless communication unit and autonomously obtain the network information (e.g., radio quality) regarding the mobile network 5. Alternatively, the mobile station 4 may receive the network information regarding the mobile network 5 from the control apparatus 8. In Step S202, the mobile station 4 decides on the communication path of the mobile station 3 based on the obtained network information.

Moreover, in response to the decision made to select the first communication path that is via the mobile network 5 as the communication path of the mobile station 3, the mobile station 4 stops wireless transmissions on the second wireless connection to the mobile station 3 (Step S203). On the other hand, in response to the decision made to select the second communication path that is via the mobile station 4 and the mobile network 6 as the communication path of the mobile station 3, the mobile station 4 initiates (or continues) the wireless transmissions for the second wireless connection to the mobile station 3. The wireless transmission may be stopped by stopping at least transmission of one of radio signals, control information, and user data through the wireless access technology used for the second wireless transmission. Alternatively, the wireless transmission may be stopped by stopping a transmission regarding a communication that is identified by a first identifier used for the second wireless connection. In this case, the mobile station 4 may continue a transmission regarding a communication that is identified by a second identifier, which is different from the first identifier. The first and second identifiers are, for example, SSIDs (Service Set Identifiers) of a wireless LAN. Therefore, the mobile station 4 can continue communications with other mobile stations while performing path control for allocating the mobile station 3 to the first communication path.

In Step S204, the mobile station 3 evaluates availability of the first and second wireless connections. When the second wireless connection is unavailable due to the transmission being stopped by the mobile station 4, the mobile station 3 communicates with the end node using the first communication path via the mobile network 5 (Step S205). Meanwhile, when the second wireless connection is available, the mobile station 3 communicates with the end node using the second communication path via the mobile station 4 and the mobile network 6 (Step S206).

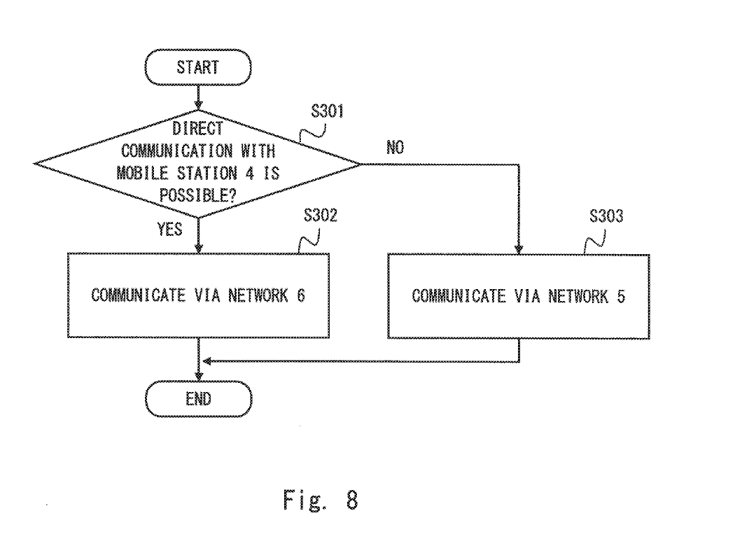

FIG. 8 is a flowchart showing an operation example of the mobile station 3 according to this exemplary embodiment. Initiation of the flow shown in FIG. 8 is triggered by data transmission or reception by the mobile station 3. In Step S301, the mobile station 3 evaluates whether or not a direct communication with the mobile station 4 is possible. Specifically, the mobile station 3 may evaluate that the direct communication is possible when a radio signal and broadcast information (a beacon, a probe response, or an SSID) from the mobile station 4 for establishing the second wireless connection are detected. When the mobile station 3 evaluates whether or not the direct communication is possible using the probe response, the mobile station 3 may send a probe request. When the direct communication is possible (YES in Step S301), the mobile station 3 directly communicates with the mobile station 4 and is connected to the external network 7 through the mobile network 6 (Step S302). When the direct communication is not possible (NO in Step S301), the mobile station 3 is connected to the external network 7 through the mobile network 5 (Step S303).

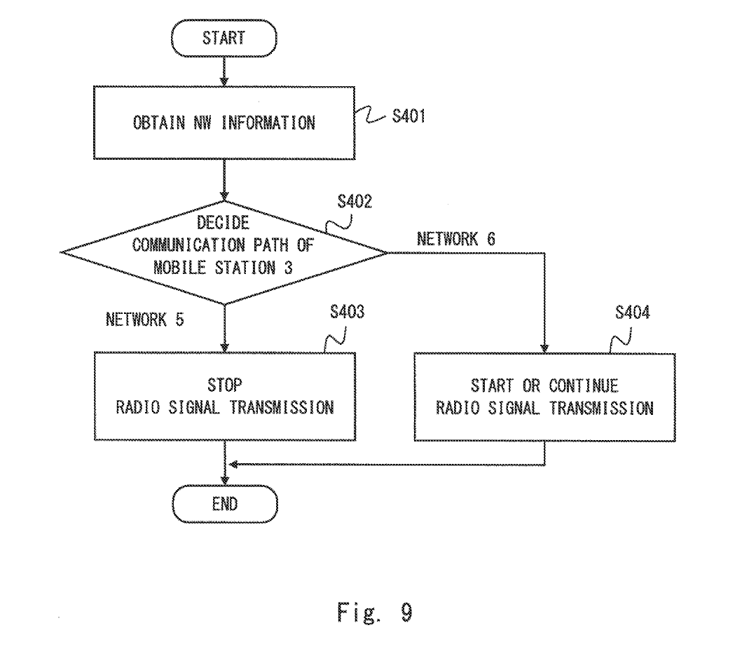

FIG. 9 is a flowchart showing an operation example of the mobile station 4 according to this exemplary embodiment. In Step S401, the mobile station 4 obtains the network information regarding the mobile networks 5 and 6. In Step S402, the mobile station 4 decides on the communication path of the mobile station 3. In response to the decision made to select the first communication path that is via the mobile network 5 as the communication path of the mobile station 3, the mobile station 4 stops the radio signal transmission on the second wireless connection to the mobile station 3 (Step S403). On the other hand, in response to the decision made to select the second communication path that is via the mobile station 4 and the mobile network 6 as the communication path of the mobile station 3, the mobile station 4 initiates (or continues) the transmission of the radio signal, the broadcast information, and the user data on the second wireless connection to the mobile station 3.

As described above, the mobile station 4 (e.g., a mobile router) according to this exemplary embodiment decides on the communication path of the mobile station 3 without receiving the network information regarding the mobile network 5 from the mobile station 3 and stops the transmission on the second wireless connection so as to control the communication path of the mobile station 3. Accordingly, the mobile station 3 does not need to implement additional functions for obtaining the network information, for transmission and reception of the network information, and for deciding on the communication path. Thus, this exemplary embodiment can improve a throughput and enables an efficient use of network resources based on the control of the communication path while using an existing mobile station as the mobile station 3.

### Third Exemplary Embodiment

In this exemplary embodiment, a specific example of the first exemplary embodiment shall be explained. A network configuration of this exemplary embodiment may be the same as that shown in FIG. 1. In this exemplary embodiment, the processing unit for deciding on the communication path of the mobile station 3 is disposed in the mobile station 3 or the mobile station 4 (e.g., a mobile router). The network information regarding the mobile network 5 is obtained by the mobile station 3, while the network information regarding the mobile network 6 is obtained by the mobile station 4.

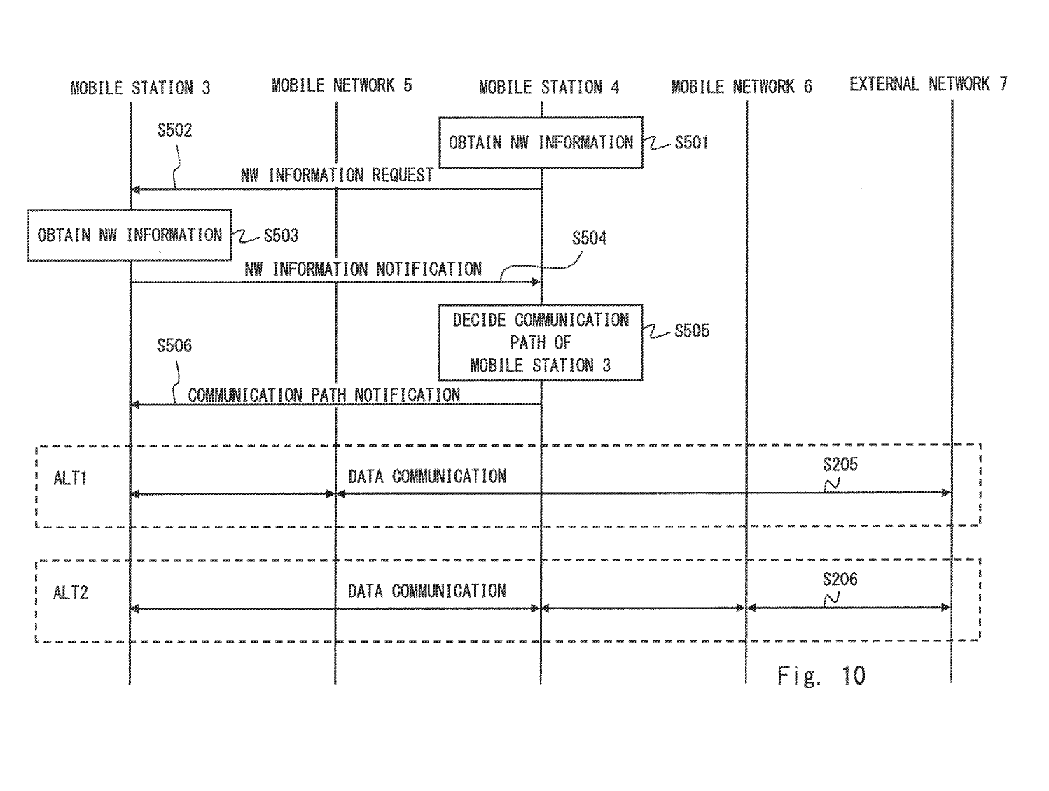

FIG. 10 is a sequence showing a specific operation example of this exemplary embodiment. FIG. 10 shows operations of the mobile stations 3 and 4, the mobile networks 5 and 6, and the external network 7. In Step S501, the mobile station 4 obtains (measures) the network information regarding the mobile network 6. In Step S502, the mobile station 4 sends a network information request to the mobile station 3 through the direct communication via the second wireless connection. In response to the network information request, the mobile station 3 obtains (measures) the network information regarding the mobile network 5 (Step S502) and sends the obtained network information to the mobile station 4 (Step S504). The mobile station 4 decides on the communication path of the mobile station 3 based on the network information regarding the mobile network 6 that has been measured by the mobile station 4 itself and the network information regarding the mobile network 5 that has been received from the mobile station 3 (Step S505). In Step S506, the mobile station 4 notifies the mobile station 3 of the decided communication path. The processing of Steps S205 and S206 shown in FIG. 10 is the same as the processing of Steps S205 and 206 shown in FIG. 7.

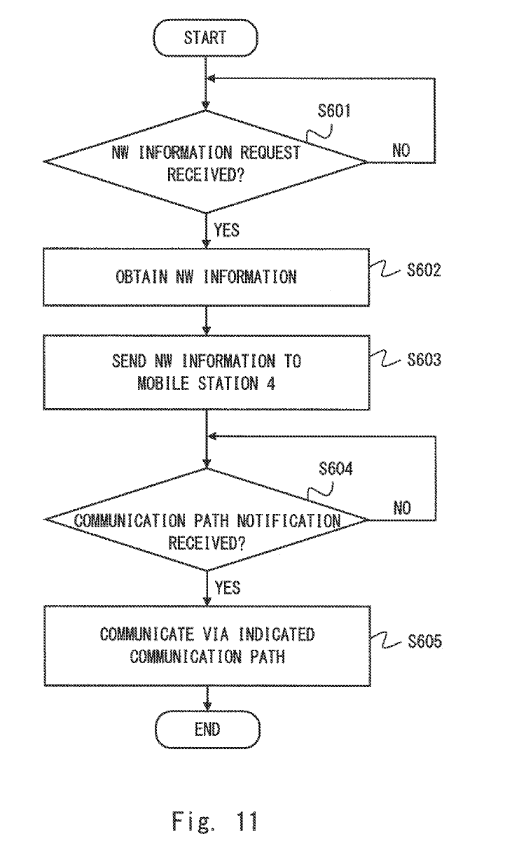

FIG. 11 is a flowchart showing an operation example of the mobile station 3 according to this exemplary embodiment. Initiation of the flow shown in FIG. 11 is triggered by receiving the network information request at the mobile station 3. In Step S601, the mobile station 3 evaluates whether or not the network information request is received from the mobile station 4. When the network information request is received (YES in Step S601), the mobile station 3 obtains (measures) the network information of the mobile network 6 (S602), sends the obtained information to the mobile station 4 (Step S603), and proceeds to Step S604 for evaluating a reception of a communication path notification from the mobile station 4. When the communication path notification is received (YES in Step S604), the mobile station 3 selects the first or second communication path based on the notification and communicates with the end node (Step S605).

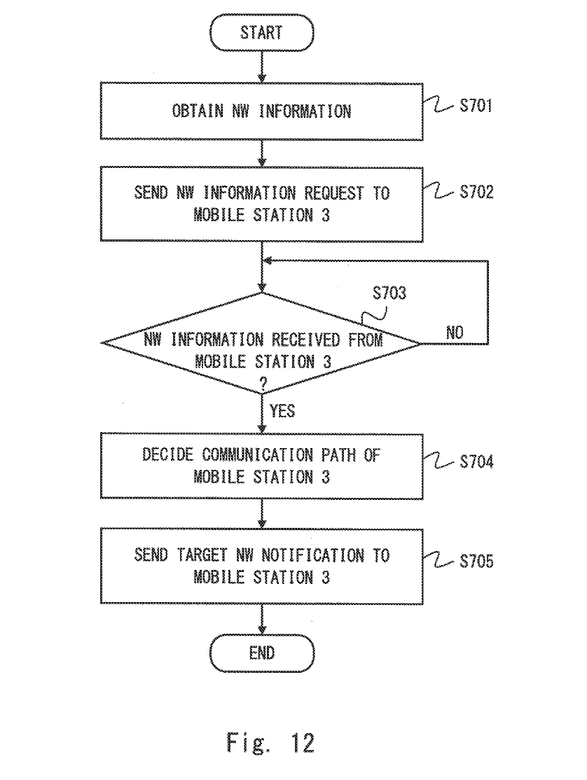

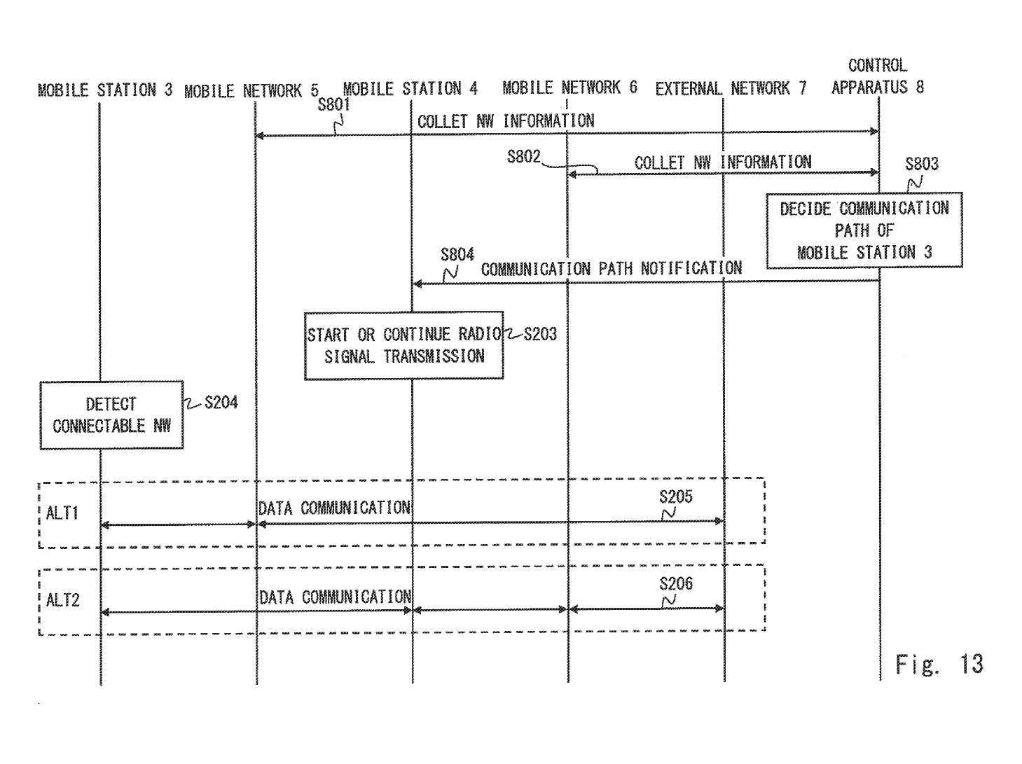

FIG. 12 is a flowchart showing an operation example of the mobile station 4 according to this exemplary embodiment. In Step S701, the mobile station 4 obtains (measures) the network information regarding the mobile network 6. In Step S702, the mobile station 4 sends the network information request to the mobile station 3 and proceeds to Step S703 for evaluating a reception of the network information. When the network information regarding the mobile network 5 is received from the mobile station 3 (YES in Step S703), the mobile station 4 decides on the communication path of the mobile station 3 based on the network information regarding the mobile networks 5 and 6 (Step S704) and sends a notification indicating the decided communication path to the mobile station 3 (Step S705).

Further, in a manner similar to that of the second exemplary embodiment, in response to the decision to select the first communication path that is via the mobile network 5 as the communication path of the mobile station 3, the mobile station 4 according to this exemplary embodiment may stop the transmission on the second wireless connection to the mobile station 3. In this case, the communication path notification sent from the mobile station 4 to the mobile station 3, which is shown in S506 of FIG. 10 or S705 of FIG. 12, may be omitted. Moreover, the mobile station 4 may notify the mobile station 3 of the information indicating on or off of the second wireless connection.

Additionally, although in the specific examples shown in FIGS. 10 to 12, the mobile station 4 starts obtaining (measuring) the network information before the mobile station 3 does, it is obvious that the mobile station 3 may start obtaining (measuring) the network information before the mobile station 4 does. Specifically, after the mobile station 3 obtains the network information of the mobile network 5 and sends the obtained network information to the mobile station 4, the mobile station 4 may obtain the network information of the mobile network 6.

Further, in the specific examples shown in FIGS. 10 to 12, although the decision on the communication path of the mobile station 3 is made by the mobile station 4, the decision may be made by the mobile station 3. That is, the mobile station 4 may send the network information regarding the mobile network 6 to the mobile station 3.

As explained above, the mobile stations 3 and 4 according to this exemplary embodiment measure the wireless quality and the like of the mobile network 5 or 6 which the mobile stations 3 and 4 are connected to, respectively. Next, the mobile station 3 or 4 decides on an appropriate communication path of the mobile station 3. Therefore, this exemplary embodiment can collect the network information while distributing functions necessary for the measurement to obtain the network information or while distributing loads. Thus, this exemplary embodiment can efficiently improve connection stability, improve a throughput, and efficiently use network resources based on the control of the communication path without using a high-performance mobile station.

### Fourth Exemplary Embodiment

In this exemplary embodiment, a specific example of the first exemplary embodiment shall be explained. A network configuration of this exemplary embodiment may be the same as that shown in FIG. 1. In this exemplary embodiment, the control apparatus 8 signals the mobile networks 5 and 6 and obtains the network information of the mobile networks 5 and 6. In some implementations of this exemplary embodiment, the processing unit for deciding on the communication path of the mobile station 3 is disposed in the control apparatus 8. Alternatively, in some implementations of this exemplary embodiment, the processing unit for deciding on the communication path of the mobile station 3 is disposed in the mobile station 3 or 4. In this case, the mobile station 3 or 4 receives the network information regarding the mobile networks 5 and 6 from the control apparatus 8.

FIG. 13 is a sequence showing a specific operation example of this exemplary embodiment. FIG. 13 shows operations of the mobile stations 3 and 4, the mobile networks 5 and 6, and the external network 7. In Steps S801 and S802, the control apparatus 8 collects the network information from the mobile networks 5 and 6. The control apparatus 8 decides on the communication path of the mobile station 3 based on the collected network information (Step S803) and sends a notification indicating the decided communication path to the mobile station 3 (Step S804). The processing of Steps S203 to S206 shown in FIG. 13 is the same as the processing of Steps S203 to 206 shown in FIG. 7.

Note that the control apparatus 8 may send the notification indicating the decided communication path to the mobile stations 3 and 4. Further, the control apparatus 8 may send the notification indicating the decided communication path to the mobile station 3 but not to the mobile station 4. In this case, the control apparatus 8 may notify the mobile station 4 of a stop permission regarding the second wireless connection. When the control apparatus 8 notifies the mobile station 4 of the communication path of the mobile station 3 or the stop permission regarding the second wireless connection, the mobile station 4 can easily stop the transmission on the second wireless connection (Step S203), as shown in FIG. 13.

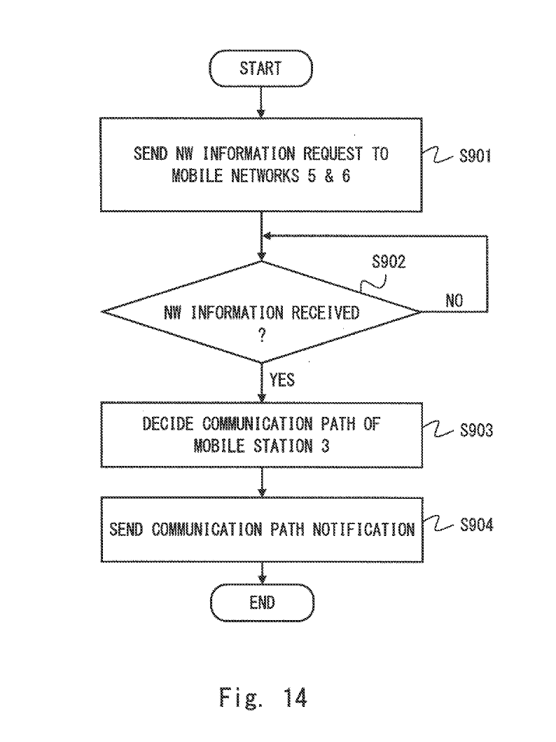

FIG. 14 is a flowchart showing an operation example of the control apparatus 8 according to this exemplary embodiment. In Step S901, the control apparatus 8 sends a network information request to a network apparatus (e.g., the base station 1, the base station 2, a core network node, and the network management system) inside the mobile networks 5 and 6. In Step S902, the control apparatus 8 evaluates whether or not the network information is received. When the network information is received (YES in Step S902), the control apparatus 8 decides on the communication path of the mobile station 3 (Step S903) and sends a notification indicating the decided communication path to the mobile station 3 or 4 (Step S904).

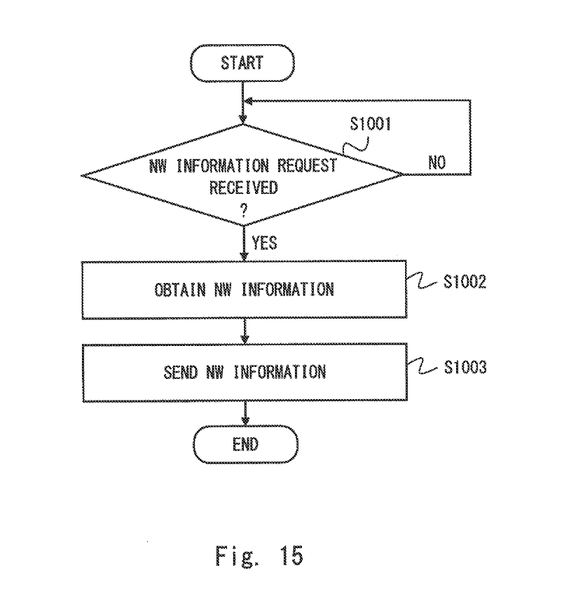

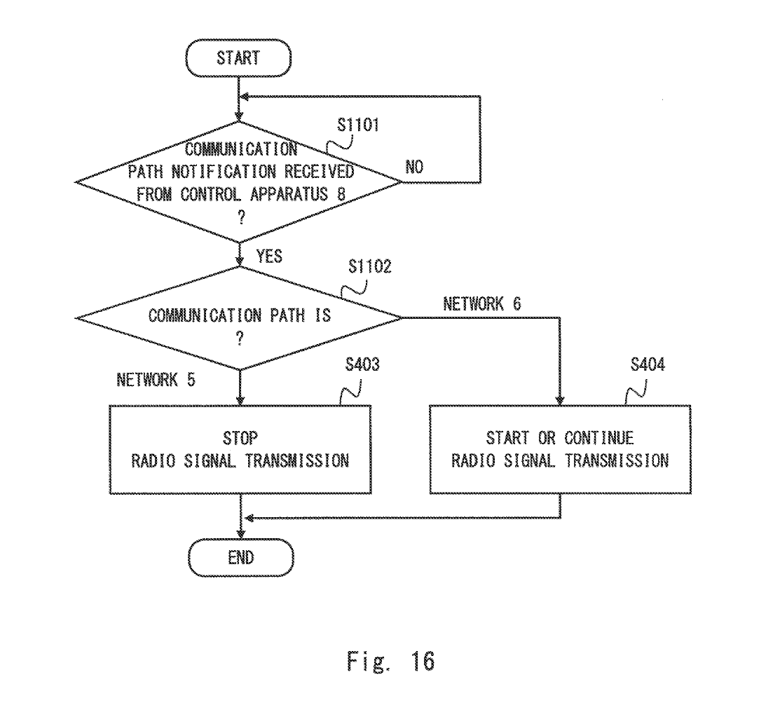

FIG. 15 is a flowchart showing an operation example of the network apparatus (the base station 1, the base station 2, the core network node, and the network management system) according to this exemplary embodiment. In Step S1001, the network apparatus evaluates whether or not the network information request is received from the control apparatus 8. When the network information request is received (YES in Step S1001), the network apparatus obtains information regarding an NW load such as a wireless resource utilization of the base station 1 or 2 and a channel usage rate of the core network as network information (Step S 1002) and sends the obtained network information to the control apparatus 8 (Step S1003).

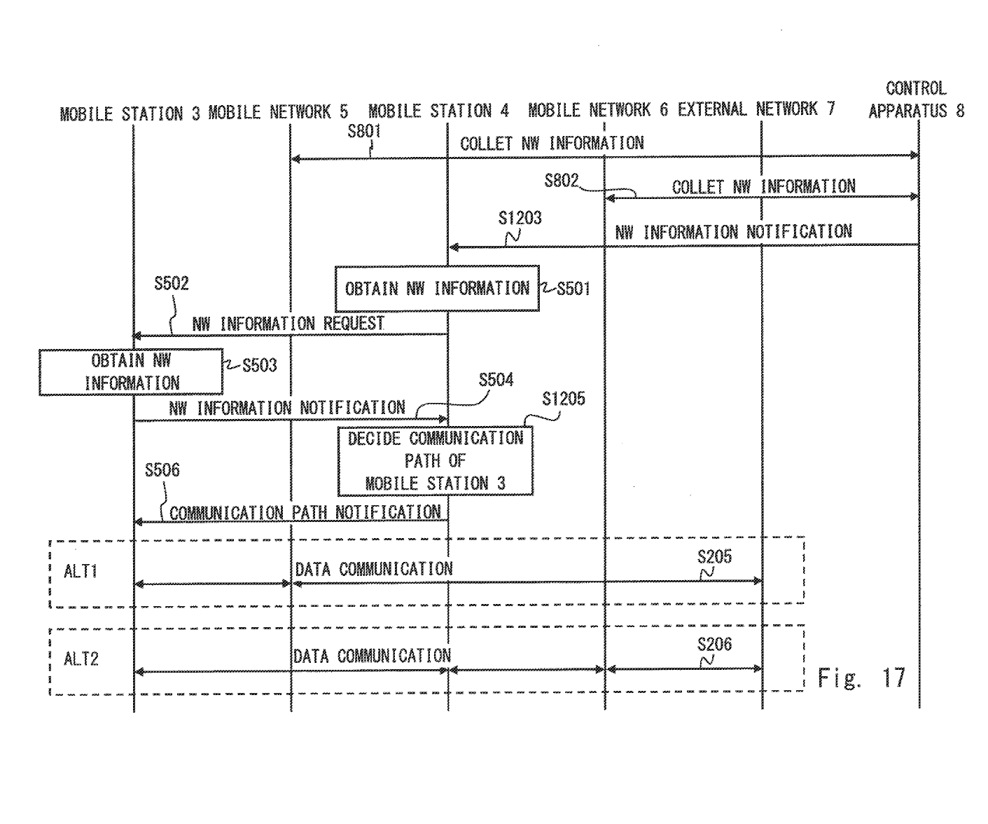

FIG. 16 is a flowchart showing an operation example of the mobile station 4 according to this exemplary embodiment. In Step S1101, the mobile station 4 receives a communication path notification indicating the communication path of the mobile station 3. When the communication path notification is received (YES in Step S1101), the mobile station 4 confirms the communication path (Step S1102). The operation for stopping or continuing the wireless transmission on the second wireless connection according to the communication path of the mobile station 3 is the same as Steps S403 and S404 that are shown in FIG. 9.

Note that in the specific examples shown in FIGS. 13 to 16, the communication path of the mobile station 3 is decided on by the control apparatus 8. However, the decision on the communication path of the mobile station 3 may be made by the mobile station 3 or 4. In this case, the mobile station 3 or 4 receives the network information regarding the mobile networks 5 and 6 from the control apparatus 8.

As described above, in this exemplary embodiment, the most appropriate communication path of the mobile station 3 is decided on according to a load state and the like of the network apparatus. Accordingly, in this exemplary embodiment, it is possible to select the communication path of the mobile station 3 based on information of a network side that is difficult for the mobile stations 3 and 4 to measure.

### Fifth Exemplary Embodiment

In this exemplary embodiment, a specific example of the first exemplary embodiment shall be explained. A network configuration of this exemplary embodiment may be the same as that shown in FIG. 1. In this exemplary embodiment, a combination of the above-described third and fourth exemplary embodiments shall be explained. Specifically, the mobile stations 3 and 4 collect the network information regarding the mobile networks 5 and 6 which the mobile stations 3 and 4 are connected to, respectively. Further, the control apparatus 8 also collects the network information regarding the mobile networks 5 and 6. Next, the mobile station 3 or 4 decides on the communication path of the mobile station 3 using both of the network information obtained by the mobile stations 3 and 4 and the network information obtained by the control apparatus 8.

FIG. 17 is a sequence showing a specific operation example of this exemplary embodiment. FIG. 17 shows operations of the mobile stations 3 and 4, the mobile networks 5 and 6, the external network 7, and the control apparatus 8. Steps S801 and S802 of FIG. 17 are the same as Steps S801 and S802 of FIG. 13, respectively. In Step S1203 of FIG. 17, the control apparatus 8 sends the network information regarding the mobile networks 5 and 6 to the mobile station 4. Steps S501 to S504 of FIG. 17 are the same as Steps S501 to S504 of FIG. 10, respectively. In Step S1205 of FIG. 17, the mobile station 4 decides on the communication path of the mobile station 3 using both the network information obtained by the control apparatus 8 and the network information obtained by the mobile stations 3 and 4. Steps S506, S205, and S206 of FIG. 17 are the same as Steps S506, S205, and S206 of FIG. 10, respectively.

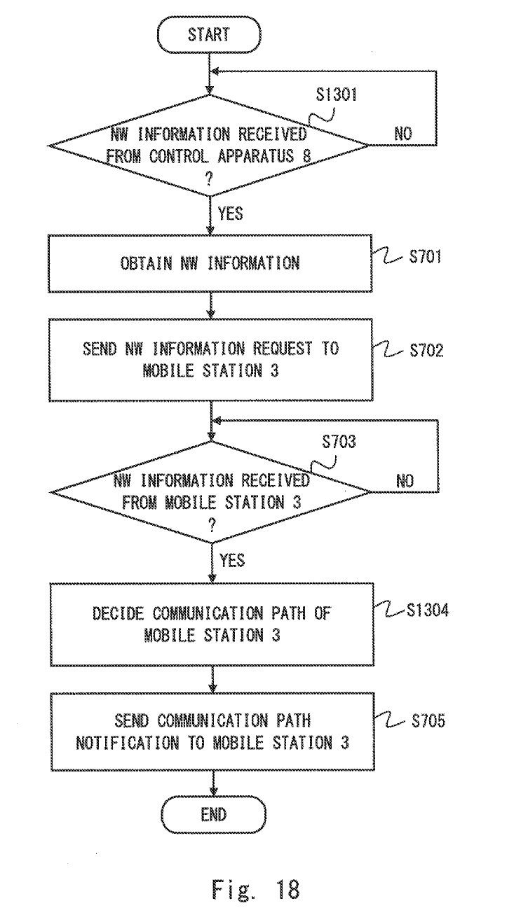

FIG. 18 is a flowchart showing an operation example of the mobile station 4 according to this exemplary embodiment. In Step S1301, the mobile station 4 receives the network information obtained by the control apparatus 8 from the control apparatus 8. Steps S701 to S703 of FIG. 18 are the same as Steps S701 to S703 of FIG. 12, respectively. In Step S1304, the mobile station 4 decides on the communication path of the mobile station 3 using both the network information obtained by the control apparatus 8 and the network information obtained by the mobile stations 3 and 4. Step S705 of FIG. 18 is the same as the Step S705 of FIG. 12.

Note that in the specific examples shown in FIGS. 17 and 18, although the decision on the communication path of the mobile station 3 is made by the mobile station 4, the decision may be made by the mobile station 3, in a manner similar to that in the third and fourth exemplary embodiments. That is, the control apparatus 8 may send the network information to the mobile station 3. Further, the mobile station 4 may send the network information regarding the mobile network 6 to the mobile station 3.

As described above, the mobile station 3 or 4 according to this exemplary embodiment decides on the communication path of the mobile station 3 based on both the network information (e.g., a wireless quality) obtained by the mobile station 3 or 4 and the network information (e.g., a network load) obtained by the network apparatus. Accordingly, in this exemplary embodiment, a selection of the communication path of the mobile station 3 can be performed taking into account both the state of the wireless side and that of the network side.

In this exemplary embodiment, both the network information collected by the mobile stations 3 and 4 and the network information collected by the control apparatus 8 is used to decide on the communication path of the mobile station 3. As a specific decision method of deciding on the communication path, there is a method in which when the wireless quality is greater than or equal to a predetermined value, the mobile network with a low network load is selected, while when the wireless quality is less than the predetermined value, the mobile network with a good wireless quality is selected. As another method, when the contract (whether it is pay-per-use or fixed-rate) on wireless services of the mobile network 5 differs from that of the mobile network 6, a communication path with a cheaper service charge or a communication path including a fixed-rate service is preferentially used. Additionally, there is another method in which when the wireless quality of the mobile network 5 or 6 through which the preferential communication path passes falls below a predetermined value or a load of the mobile network 5 or 6 through which the preferential communication passes exceeds a predetermined value, the other communication path is used.

### Sixth Exemplary Embodiment

In this exemplary embodiment, an example in which the mobile station 3 prioritizes the communication that is via the mobile station 4, and switches the communication to that with the mobile network 5 according to a state of communication between the mobile station 3 and the mobile network 6 shall be explained. This exemplary embodiment can be used, for example, when the communication charge for communicating with the mobile network 6 via the mobile station 4 is a fixed-rate regardless of the communication volume, and the communication charge for communicating with the mobile network 5 is a pay-per-use charge system according to the communication volume.

As the configurations of the mobile stations 3 and 4 are the same as those explained in the above exemplary embodiments, a specific explanation of the configurations of the mobile stations 3 and 4 shall be omitted.

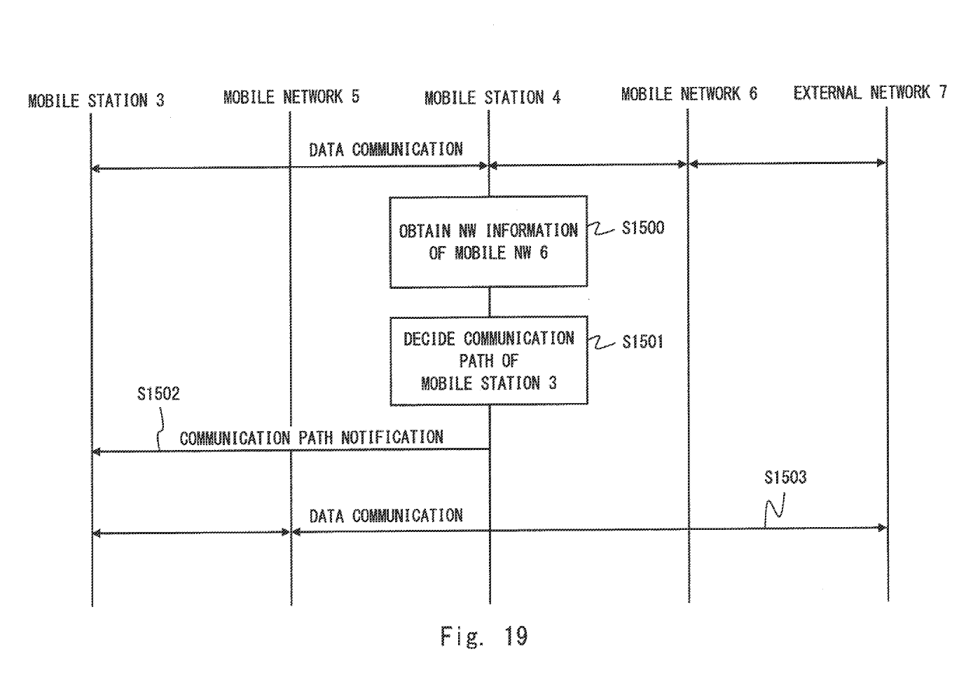

FIG. 19 is a sequence diagram showing an operation example of a sixth exemplary embodiment. Note that FIG. 19 is an example, and an operation of the sixth exemplary embodiment is not limited to the operation shown in FIG. 19. Suppose that the mobile station 3 executes a communication via the mobile station 4. The mobile station 4 monitors the network information regarding the mobile network 6 (S1500). The mobile station 4 may periodically monitor the network information at a predetermined cycle. The mobile station 4 selects the communication path that is used by the mobile station 3 for communications (i.e. the communication path via the mobile network 5 or the communication path to communicate with the mobile network 6 via the mobile station 4) (S1501). For example, when the communication quality of the mobile network 6 falls below a predetermined threshold, the mobile station 4 decides to switch the communication path from the mobile network 6 to the mobile network 5.

Note that although FIG. 19 shows the example in which the mobile station 4 selects the communication path, the control apparatus 8 or the mobile station 3 may select the communication path. The selection of the communication path may be performed by using any of the schemes in the above-described exemplary embodiments. For example, the control apparatus 8 may collect the network information regarding the mobile network 6 and select the communication path of the mobile station 3, or the mobile station 3 may receive the network information regarding the mobile network 6 from the mobile station 4 and select the communication path.

The mobile station 4 notifies the mobile station 3 of the selected communication path (S1502). Note that when the control apparatus 8 selects the communication path, the control apparatus 8 may notify the mobile station 3 of the communication path. The mobile station 3 executes a data communication through the selected communication path (S1503).

### Seventh Exemplary Embodiment

In this exemplary embodiment, a distribution server 9 for distributing, to the mobile station 3 or 4, an application (e.g., the communication path control application 311 shown in FIG. 6) which provides the function corresponding to the processing unit when the application is executed on a computer shall be explained. When the application is executed on the computer, the application operates the computer as the processing unit explained in the first to sixth exemplary embodiments, that is, the processing unit for deciding on the communication path of the mobile station 3.

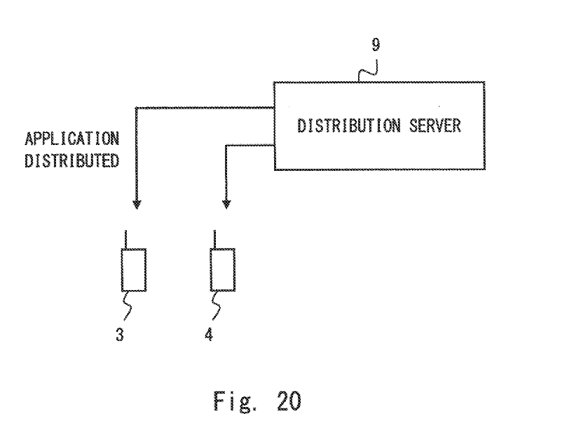

FIG. 20 illustrates an example of a system configuration of the sixth exemplary embodiment. The distribution server 9 distributes the application for providing the function that corresponds to the processing unit to the mobile stations 3 and 4. The distribution server 9 is, for example, disposed in the external network 7. The distribution server 9, for example, distributes the application to the mobile station 3 or 4 possessed by a user of a service who is appropriately selects the mobile network 5 or 6 and accesses the distribution server 9. Since the distribution server 9 distributes the application, the user of the service can avoid, for example, the burden of purchasing a dedicated apparatus for using the service.

### Other Exemplary Embodiments

The first to seventh exemplary embodiments can be combined as appropriate.

Although the first to seventh exemplary embodiments show a mobile router as a specific example of the mobile station 4, the mobile station 4 may be a terminal that can provide wireless access to other wireless devices, such as a smartphone, as has already been mentioned.

Moreover, the above-described exemplary embodiments are merely examples regarding application of technical concepts obtained by the present inventors. That is, it is obvious that the technical concepts are not limited to the above-described exemplary embodiments, and various modifications can be made.

The present application is based upon and claims the benefit of priority from Japanese Patent Application No. 2012-73856 filed on Aug. 6, 2012, the entire disclosure of which are hereby incorporated by reference.

### REFERENCE SIGNS LIST

1BASE STATION
2 BASE STATION
3 MOBILE STATION
4 MOBILE STATION (e.g., MOBILE ROUTER)
5 MOBILE NETWORK
6 MOBILE NETWORK
7 EXTERNAL NETWORK
8 CONTROL APPARATUS
9 DISTRIBUTION SERVER
31 WIRELESS COMMUNICATION UNIT
32 COMMUNICATION PATH CONTROL UNIT
41 WIRELESS COMMUNICATION UNIT
42 WIRELESS COMMUNICATION UNIT
43 COMMUNICATION PATH CONTROL UNIT
81 LOWER-LEVEL APPARATUS COMMUNICATION UNIT
82 COMMUNICATION PATH CONTROL UNIT
301 CELLULAR WIRELESS TRANSCEIVER
302 WIRELESS LAN TRANSCEIVER
303 APPLICATION PROCESSOR
304 BASEBAND PROCESSOR
305 MICROPHONE
306 SPEAKER
307 TOUCH PANEL
308 DISPLAY
309 NON-VOLATILE STORAGE UNIT
310 OS (OPERATING SYSTEM)
311 COMMUNICATION PATH CONTROL APPLICATION

1. A communication apparatus capable of communicating by a plurality of wireless access technologies, the communication apparatus comprising:
a first communication unit configured to be wirelessly connected to a first network;
a second communication unit configured to be wirelessly connected to another communication apparatus, said another communication apparatus being wirelessly connected to a second network; and
a control unit configured to perform control on whether to use either the first communication unit or the second communication unit in accordance with the network selected from the first and second networks based on information regarding the second network.

2. The communication apparatus according to claim 1, wherein the control unit performs the control on whether to use either the first communication unit or the second communication unit in accordance with the network selected from the first and second networks based on first information regarding the first network and second information regarding the second network.

3. The communication apparatus according to claim 1, wherein the control unit performs the control on whether to use either the first communication unit or the second communication unit in order to communicate in accordance with the network selected from the first and second networks based on information regarding the second network collected by said another communication apparatus.

4. The communication apparatus according to claim 1, wherein the control unit performs the control on whether to use either the first communication unit or the second communication unit in order to communicate in accordance with the network selected by said another communication apparatus from the first and second networks based on the first information and the second information collected by said another communication apparatus.

5. The communication apparatus according to claim 2, wherein the control unit performs the control on whether to use either the first communication unit or the second communication unit in order to communicate in accordance with the network selected from the first and second networks based on the first information collected by the communication apparatus and the second information collected by said another communication apparatus.

6. The communication apparatus according to claim 5, wherein
the communication apparatus receives the second information that is collected by said another communication apparatus from said another communication apparatus via the second communication unit.

7. The communication apparatus according to claim 5, wherein the communication apparatus sends the first information that is collected by the communication apparatus to said another communication apparatus via the second communication unit.

8. The communication apparatus according to claim 1, wherein the control unit performs the control on whether to use either the first communication unit or the second communication unit in order to communicate in accordance with the network selected from the first and second networks based on the information regarding the second network collected by a management apparatus.

9. The communication apparatus according to claim 1, wherein the control unit performs the control on whether to use either the first communication unit or the second communication unit in order to communicate in accordance with the network selected from the first and second networks based on first information regarding the first network and second information regarding the second network, wherein the first and second information is collected by a management apparatus.

10. The communication apparatus according to claim 1, wherein the control unit performs the control on whether to use either the first communication unit or the second communication unit in order to communicate in accordance with the network selected by a management apparatus from the first and second networks based on the information regarding the second network.

11. The communication apparatus according to claim 2, wherein the control unit performs the control on whether to use either the first communication unit or the second communication unit in order to communicate in accordance with the network selected from the first and second networks by a management apparatus based on the first information and the second information.

12. The communication apparatus according to claim 1, wherein the first network and the second network each include a cellular network operated by an operator, which operators are different from each other.

13. A communication method performed by a communication apparatus including a first communication unit configured to be wirelessly connected to a first network and a second communication unit configured to be wirelessly connected to another communication apparatus that is wirelessly connected to a second network, the communication method comprising:
performing control on whether to use either the first communication unit or the second communication unit in accordance with the network selected from the first and second networks based on information regarding the second network; and
communicating through the first network or the second network.

14. The communication method according to claim 13, wherein the performing includes performing the control on whether to use either the first communication unit or the second communication unit in accordance with the network selected from the first and second networks based on first information regarding the first network and second information regarding the second network.

15. The communication method according to claim 13, wherein the performing includes performing the control on whether to use either the first communication unit or the second communication unit in order to communicate in accordance with the network selected from the first and second networks based on information regarding the second network collected by said another communication apparatus.

16. The communication method according to claim 13, wherein the performing includes performing the control on whether to use either the first communication unit or the second communication unit in order to communicate in accordance with the network selected by said another communication apparatus from the first and second networks based on the first information and the second information collected by said another communication apparatus.

17. The communication method according to claim 14, wherein the performing includes performing the control on whether to use either the first communication unit or the second communication unit in order to communicate in accordance with the network selected from the first and second networks based on the first information collected by the communication apparatus and the second information collected by said another communication apparatus.

18. The communication method according to claim 17, further including receiving the second information that is collected by said another communication apparatus from said another communication apparatus via the second communication unit.

19. The communication method according to claim 17, further including sending the first information that is collected by the communication apparatus is sent to said another communication apparatus via the second communication unit.

20. The communication method according to claim 13, wherein the performing includes performing the control on whether to use either the first communication unit or the second communication unit in order to communicate in accordance with the network selected from the first and second networks based on the information regarding the second network collected by a management apparatus.

21. The communication method according to claim 13, wherein the performing includes performing the control on whether to use either the first communication unit or the second communication unit in accordance with the network selected from the first and second networks based on first information regarding the first network and second information regarding the second network, wherein the first and second information is collected by a management apparatus.

22. The communication method according to claim 13, wherein the performing includes performing the control on whether to use either the first communication unit or the second communication unit in accordance with the network selected by a management apparatus from the first and second networks based on the information regarding the second network.

23. The communication apparatus according to claim 14, wherein the performing includes performing the control on whether to use either the first communication unit or the second communication unit in order to communicate in accordance with the network selected by a management apparatus from the first and second networks based on the first information and the second information.

24. The communication method according to claim 13, wherein the first network and the second network each include a cellular network operated by an operator, which operators are different from each other.

25. A communication apparatus capable of communicating by a plurality of wireless access technologies, the communication apparatus comprising:
a first communication unit configured to be wirelessly connected to a first network;
a second communication unit configured to be wirelessly connected to another communication apparatus, said another communication apparatus being wirelessly connected to a second network; and
a control unit configured to select, based on information regarding the second network, either the first network or the second network to be used by said another communication apparatus.

26. The communication apparatus according to claim 25, wherein the control unit selects either the first network or the second network to be used by said another communication apparatus, based on first information regarding the first network and second information regarding the second network.

27. The communication apparatus according to claim 26, wherein the control unit obtains the second information not through said another communication apparatus.

28. The communication apparatus according to claim 25, further comprising a wireless control unit configured to stop a wireless transmission by the second means when the second network is selected as the network to be used by said another communication apparatus.

29. The communication apparatus according to claim 28, wherein the wireless control unit stops transmissions of at least one of a radio signal, control information, and user data through a wireless access technology used by the second communication unit.

30. The communication apparatus according to claim 28, wherein the wireless control unit stops a transmission regarding a communication identified by a first identifier that is used for a wireless connection by the second communication unit and performs a transmission regarding a communication identified by a second identifier that is different from the first identifier.

31. The communication apparatus according to claim 30, wherein the first identifier and the second identifier are SSIDs (Service Set Identifiers).

32. A communication method performed by a communication apparatus including a first communication unit configured to be wirelessly connected to a first network and a second communication unit configured to be wirelessly connected to another communication apparatus that is wirelessly connected to a second network, the communication method comprising:
selecting either the first network or the second network to be used by said another communication apparatus based on information regarding the second network; and
communicating through the selected network.

33. A non-transitory computer readable medium storing a program, the program causing a communication apparatus to execute a process, the communication apparatus including a first communication unit configured to be wirelessly connected to a first network and a second communication unit configured to be wirelessly connected to another communication apparatus that is wirelessly connected to a second network, the process including performing control on whether to use either the first communication unit or the second communication unit in accordance with the network selected from the first and second networks based on information regarding the second network.

34. A non-transitory computer readable medium storing a program, the program causing a communication apparatus to execute a process, the communication apparatus including a first communication unit configured to be wirelessly connected to a first network and a second communication unit configured to be wirelessly connected to another communication apparatus that is wirelessly connected to a second network, the process including selecting either of the first network or the second network to be used by said another communication apparatus based on information regarding the second network.

35. A distribution server comprising:
a distributing unit configured to distribute a program to a communication apparatus, the communication apparatus including a first communication unit configured to be wirelessly connected to a first network and a second communication unit configured to be wirelessly connected to another communication apparatus that is wirelessly connected to a second network, the program causing the communication apparatus to execute a process for performing control on whether to use either the first communication unit or the second communication unit in accordance with the network selected from the first and second networks based on information regarding the second network.

36. A distribution server comprising:
a distributing unit configured to distribute a program to a communication apparatus, the communication apparatus including a first communication unit configured to be wirelessly connected to a first network and a second communication unit configured to be wirelessly connected to another communication apparatus that is wirelessly connected to a second network, the program causing the communication apparatus to execute a process for selecting either of the first network or the second network to be used by said another communication apparatus based on information regarding the second network.
